(19) United States
(12) Patent Application Publication
(10) Pub. No.: US 2026/0269971 A1
(43) Pub. Date: Sep. 10, 2026

(54) RADIO FREQUENCY JAMMER UTILIZING ANTENNA ARRAY

(71) Applicant: TRON FUTURE TECH INC., HSINCHU CITY (TW)

(72) Inventors: KUN-CHIEN HUNG, HSINCHU CITY (TW); CHIEN CHENG WANG, HSINCHU CITY (TW); YU-JIU WANG, HSINCHU CITY (TW); BOR-CHING SU, HSINCHU CITY (TW)

(21) Appl. No.: 18/747,508

(22) Filed: Jun. 19, 2024

Related U.S. Application Data
(60) Provisional application No. 63/508,973, filed on Jun. 19, 2023.
(60) Provisional application No. 63/509,525, filed on Jun. 21, 2023.

(51) Int. Cl. H04K 3/00; H04B 1/40; H04B 7/0426

(52) U.S. Cl. CPC H04K 3/43; H04B 1/40; H04B 7/043

(57) ABSTRACT

A radio frequency (RF) jammer includes a processing circuit, an RF frontend module and an antenna array. The processing circuit has a multi-channel interface, and is configured to transmit N sets of output signals via the multi-channel interface. N is an integer greater than one. The RF frontend module, coupled to the multi-channel interface, is configured to receive the N sets of output signals to generate N sets of RF signals. A phase relationship between RF signals in each set of RF signals is determined according to position information on a target device. The antenna array, coupled to the RF frontend module, is arranged to receive the N sets of RF signals to emit N beamforming signals directed to the target device, respectively. N frequencies of the N beamforming signals are within N operating frequency bands of the target device.

### PRIORITY CLAIM AND CROSS-REFERENCE

The present application claims priority to U.S. Provisional Patent Applications including Ser. No. 63/508,973, filed on Jun. 19, 2023, and Ser. No. 63/509,525, filed on Jun. 21, 2023, each of which is incorporated by reference herein in its entirety.

### BACKGROUND

The present disclosure relates to signal jamming and, more particularly, to a radio frequency jammer utilizing an antenna array.

Due to the diverse applications of drones (also known as unmanned aerial vehicles, UAVs), such as aerial photography, reconnaissance, remote sensing, package delivery and personal use, the demand for drones has significantly increased in recent years. Affordability, portability, and ease of use are some of the reasons that make drones widely popular. However, the misuse of drones can pose serious threats to personal safety, critical facilities, and national infrastructure. For example, whether a drone unintentionally or maliciously enters restricted airspace (e.g. airports, military bases, or protected facilities), it poses a certain threat to aviation safety. Thus, there is a need in the art for an effective counter-drone defense system to counteract malicious drone activities.

### SUMMARY

The described embodiments provide a radio frequency jammer utilizing an antenna array.

Some embodiments described herein may include a radio frequency (RF) jammer. The RF jammer includes a processing circuit, an RF frontend module and an antenna array. The processing circuit has a multi-channel interface, and is configured to transmit N sets of output signals via the multi-channel interface. N is an integer greater than one. The RF frontend module, coupled to the multi-channel interface, is configured to receive the N sets of output signals to generate N sets of RF signals. A phase relationship between RF signals in each set of RF signals is determined according to position information on a target device. The antenna array, coupled to the RF frontend module, is arranged to receive the N sets of RF signals to emit N beamforming signals directed to the target device.

Some embodiments described herein may include a radio frequency (RF) jammer. The RF jammer includes a processing circuit, a first RF frontend circuit and an antenna array. The processing circuit has a multi-channel interface, and is configured to generate an output signal having a frequency falling within an operating frequency band of a target device. The first RF frontend circuit, coupled to the multi-channel interface, is configured to receive the output signal to generate M RF signals. M is an integer greater than one. The first RF frontend circuit includes a divider stage, a phase shifting stage and an amplifier stage. The divider stage is arranged to split the output signal into M electrical signals. The phase shifting stage, coupled to the divider stage, is configured to perform phase shifting operation on the M electrical signals according to position information on the target device, and accordingly generate M phase shifted signals. The amplifier stage, coupled to the phase shifting stage, is configured to amplify the M phase shifted signals to generate the M RF signals. The antenna array, coupled to the amplifier stage, is arranged to receive the M RF signals to emit a beamforming signal directed to the target device.

Some embodiments described herein may include a radio frequency (RF) jammer. The RF jammer includes a processing circuit, M first RF frontend circuits and an antenna array. M is an integer greater than one. The processing circuit has a multi-channel interface, and is configured to generate M output signals according to an operating frequency band of a targer device and position information on the target device. The M output signals have a same frequency falling within the operating frequency band, and a phase relationship between the M output signals is determined according to the position information. The M first RF frontend circuits, coupled to M channels of the multi-channel interface respectively, are configured to receive the M output signals via the M channels to generate M RF signals, respectively. The antenna array, coupled to the M first RF frontend circuits, is arranged to receive the M RF signals to emit a beamforming signal directed to the target device.

With the use of active phased array architecture, the proposed RF jammer not only can interfere with and/or neutralize operation of a target device in an active and real-time manner, but also can achieve multi-band or full-band signal interception. Additionally, the proposed RF jammer can incorporate frequency band detection and/or target position detection, thereby achieving an active defense system.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a block diagram illustrating an exemplary radio frequency jammer in accordance with some embodiments of the present disclosure.

FIG. 2 is a diagram illustrating a gain compression curve of the power amplifier shown in FIG. 1 in accordance with some embodiments of the present disclosure.

FIG. 3 is a block diagram of an implementation of the radio frequency jammer shown in FIG. 1 in accordance with some embodiments of the present disclosure.

FIG. 4 is a block diagram of the radio frequency frontend circuit shown in FIG. 3 in accordance with some embodiments of the present disclosure.

FIG. 5 is a diagram of an implementation of the radio frequency frontend circuit shown in FIG. 4 in accordance with some embodiments of the present disclosure.

FIG. 6 is a block diagram of another implementation of the radio frequency jammer shown in FIG. 1 in accordance with some embodiments of the present disclosure.

FIG. 7 is a diagram of an implementation of two adjacent radio frequency frontend circuits shown in FIG. 6 in accordance with some embodiments of the present disclosure.

FIG. 8 is a block diagram of another implementation of the radio frequency jammer shown in FIG. 1 in accordance with some embodiments of the present disclosure.

FIG. 9 is a block diagram of an implementation of the radio frequency jammer shown in FIG. 1 in accordance with some embodiments of the present disclosure.

FIG. 10 is a block diagram of an implementation of the radio frequency jammer shown in FIG. 1 in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the present disclosure may repeat reference numerals and/or letters in the various examples. This repetition is for the purpose of simplicity and clarity and does not in itself dictate a relationship between the various embodiments and/or configurations discussed.

Further, it will be understood that when an element is referred to as being “connected to” or “coupled to” another element, it may be directly connected to or coupled to the other element, or intervening elements may be present.

Signal jamming techniques can be used to disrupt communications between a drone and its operator/controller to thereby counteract drone activities. For example, after locating the drone, a user can use a jammer gun to emit signals (e.g. Wi-Fi signals) toward a target position to interfere with the communication signals transmitted between the drone and its operator, rendering the drone uncontrollable. However, this manual jamming method is labor-intensive and may not effectively counteract drone activities in real-time, resulting in limited neutralization effectiveness.

The present disclosure describes exemplary radio frequency (RF) jammers, each of which utilizes an active phased array to generate a jamming signal through beamforming. The exemplary RF jammer can emit the jamming signal toward the position of a target device (e.g. a drone) to perform signal interception. For example, the exemplary RF jammer can use an active phased array radar to achieve phase control of a transmitting end. In addition, the jamming signal generated by the exemplary RF jammer can have a frequency range that covers multiple operating frequency bands of the target device. For example, the exemplary RF jammer may include a multi-channel processor with multiple channels to transmit multiple signals at different frequency bands. These signals can be beamformed through an antenna array to produce a jamming signal directed to the target device.

In some embodiments, the proposed RF jammer can utilize an analog phased array to generate a jamming signal. In some embodiments, the proposed RF jammer can utilize a digital phased array to generate a jamming signal. In some embodiments, the proposed RF jammer can incorporate frequency band detection. In some embodiments, the RF jammer can incorporate target position detection. Further description is provided below.

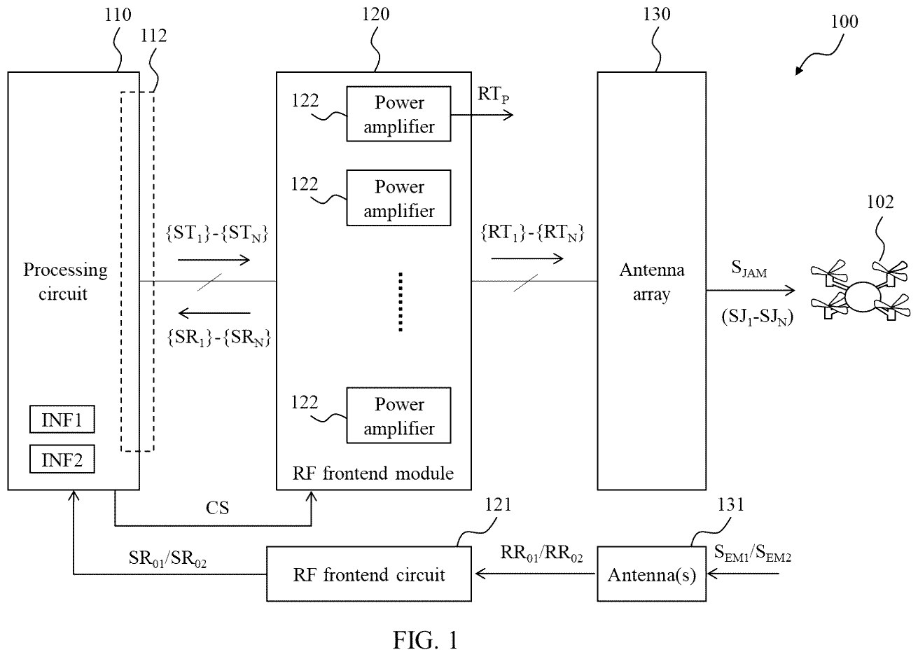

FIG. 1 is a block diagram illustrating an exemplary RF jammer in accordance with some embodiments of the present disclosure. The RF jammer 100 can be used to block, counteract, and/or neutralize the activities of the target device 102. The target device 102 can be, but is not limited to, a device controlled by wireless communication signals, such as an unmanned aerial vehicle (UAV) or drone. The RF jammer 100 can emit a jamming signal S_{JAM} to interfere with or block communication between the target device 102 and its controller (which emits the wireless communication signals). In some examples, the target device 102 can be a device that emits wireless communication signals for target detection, and the RF jammer 100 can emit the jamming signal S_{JAM} to disrupt the target detection. In some examples, the target device 102 can be a device that receives wireless communication signals to steal information, and the RF jammer 100 can emit the jamming signal S_{JAM} to prevent the target device 102 from obtaining confidential information.

The RF jammer 100 can emit the jamming signal S_{JAM} toward the target device 102 according to the position information INF1 and frequency band information INF2 on the target device 102. The position information INF1 can indicate the elevation angle, azimuth angle, and/or movement speed of the target device 102, while the frequency band information INF2 can indicate operating frequency bands of the target device 102. The operating frequency bands of the target device 102 include, but are not limited to, a control frequency bands (e.g. a frequency band of a control signal) and a communication frequency band (e.g. a frequency band of a communication signal). For example, the frequency band information INF2 can indicate the frequency and/or frequency range of a signal received by the target device 102; additionally, or alternatively, the frequency band information INF2 can indicate the frequency and/or frequency range of a signal transmitted by the target device 102.

In the present embodiment, the RF jammer 100 can be implemented as a multi-band/full-band jammer capable of simultaneously blocking remote control signals (e.g. wireless control signals in HF/UHF/Wi-Fi bands) and various global navigation satellite system (GNSS) signals. For example, the RF jammer 100 can have a broadband active electronically scanned array (AESA), and the jamming signal S_{JAM} can cover a target band that may range from tens of MHz to 6 GHz. In some embodiments, a radar (not shown in FIG. 1) can be used to detect the position of the target device 102 relative to the RF jammer 100 to provide the position information INF1. In some embodiments, a sensor (not shown in FIG. 1) can be used to detect an operating frequency band of the target device 102 to provide the frequency band information INF2. The RF jammer 100, along with the aforementioned radar and sensor, can serve as at least part of a defense system for detecting, identifying and countering the target device 102.

The RF jammer 100 may include, but is not limited to, a processing circuit 110, an RF frontend module 120 and an antenna array 130. In the present embodiment, the processing circuit 110 can be implemented using software-defined hardware to quickly respond to newly discovered threat targets. Additionally, the processing circuit 110 can be implemented using a multi-channel processor to generate a jamming signal that can cover multiple frequency bands. For example, the processing circuit 110 can be implemented as a multi-channel software-defined processor, which can be (but is not limited to) a multi-channel FPGA-based processor, a multi-channel RF software-defined processor, or a multi-channel RF system on a chip (RF SoC).

The processing circuit 110 has a multi-channel interface 112 that includes multiple channels for signal transmission. The processing circuit 110 is configured to transmit N sets of output signals {ST₁}-{ST_{N}} via the multi-channel interface 112, where N is an integer greater than one. In the present embodiment, the processing circuit 110 can determine the frequencies of the N sets of output signals {ST₁}-{ST_{N}} according to the frequency band information INF2 on the target device 102. By way of example but not limitation, output signals in a same set of output signals can have a same frequency, which is within an operating frequency band of the target device 102; output signals from different sets of output signals have different frequencies, which are within different operating frequency bands of the target device 102. Alternatively, output signals in a same set of output signals can have a same frequency range that can cover an operating frequency band of the target device 102; respective frequency ranges of output signals from different sets of output signals can cover different operating frequency bands of the target device 102.

Each set of output signals can be a singleton set having a single output signal, or a signal set including multiple output signals. In some examples, the N sets of output signals {ST₁}-{ST_{N}} can be transmitted via N sets of channels in the multi-channel interface 112, in which each set of channels can be used to transmit a corresponding set of output signals. In some examples, the N sets of output signals {ST₁}-{ST_{N}} can be transmitted via the multi-channel interface 112 during different time periods, in which the N sets of output signals {ST₁}-{ST_{N}} can share multiple channels in the multi-channel interface 112 for transmission.

The RF frontend module 120, coupled to the multi-channel interface 112, can be configured to receive the N sets of output signals {ST₁}-{ST_{N}} to generate N sets of RF signals {RT₁}-{RT_{N}}. A phase relationship between RF signals in each set of RF signals can be determined according to the position information INF1 on the target device 102. For example, the processing circuit 110 can generate a control signal CS according to the position information INF1, and the RF frontend module 120 can determine a phase shift of each RF signal in each set of RF signals according to the control signal CS. As another example, the processing circuit 110 can determine a phase shift of each output signal in each set of output signals according to the position information INF1, and the RF frontend module 120 can amplify each set of output signals to generate a corresponding set of RF signals.

The antenna array 130, coupled to the RF frontend module 120, is arranged to receive the sets of RF signals {RT₁}-{RT_{N}} to emit N beamforming signals SJ₁-SJ_{N} directed to the target device 102. The beamforming signals SJ₁-SJ_{N} can serve as an embodiment of the jamming signal S_{JAM}. The frequencies of the beamforming signals SJ₁-SJ_{N} can fall within the operating frequency bands B₁-B_{N} of the target device 102 respectively, and/or the frequency ranges of the beamforming signals SJ₁-SJ_{N} can cover the operating frequency bands B₁-B_{N} of the target device 102 respectively. For example, each set of RF signals includes multiple phase-shifted signals, which are coupled into multiple antennas (also referred to as antenna/radiating elements) of the antenna array 130 to generate multiple electromagnetic wave signals. The antenna array 130 can be implemented using an active phased array to combine the electromagnetic wave signals into a beamforming signal directed to the target device 102.

Consider an example where the RF jammer 100 is configured to generate the beamforming signal SJᵢ (i=1, 2, . . . , N) to cover the operating frequency band Bᵢ of the target device 102. In operation, the processing circuit 110 can determine or set a frequency of a set of output signals {STᵢ} (which can cover the operating frequency band Bᵢ) according to the frequency band information INF2. In other words, the bandwidth of each output signal in the set of output signals {STᵢ} can be greater than or equal to the bandwidth of the operating frequency band Bᵢ. Next, the RF frontend module 120 can receive the set of output signals {STᵢ} to generate a set of RF signals {RTᵢ}. The antenna array 130 can combine RF signals included in the set of RF signals {RTᵢ} into the beamforming signals SJᵢ directed to the target device 102. With the use of the proposed jammer architecture, the RF jammer 100 not only can interfere with and/or neutralize the operation of the target device 102 in an active and real-time manner, but also can realize multi-band/full-band signal interception.

In some embodiments, the set of output signals {STᵢ} received by the RF frontend module 120 can be a singleton set having a single output signal. The RF frontend module 120 can perform power division on the output signal to generate multiple electrical signals, and perform phase shifting operation and power amplification on the electrical signals to thereby generate the set of RF signals {RTᵢ}. In some embodiments, the set of output signals {STᵢ} received by the RF frontend module 120 can be a signal set including multiple output signals, and the phase relationship between the output signals can be determined by the processing circuit 110 according to the position information INF1. The RF frontend module 120 can perform power amplification on the output signals to thereby generate the set of RF signals {RTᵢ}.

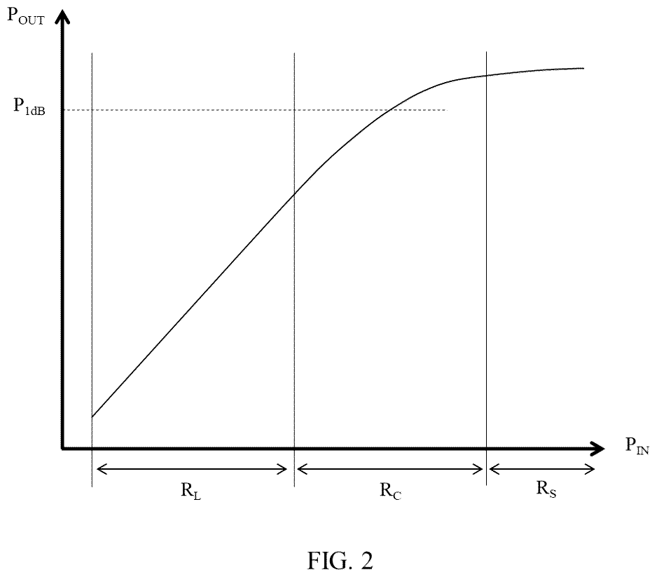

In some embodiments, each RF signal can be outputted through a corresponding power amplifier (i.e. one of the power amplifiers 122) of the RF frontend module 120. The power amplifier can operate in a compression region between a linear region and a saturation region. FIG. 2 is a diagram illustrating a gain compression curve of the power amplifier 122 shown in FIG. 1 (i.e. a relationship between the input power P_{IN} and the output power P_{OUT} of the power amplifier 122) in accordance with some embodiments of the present disclosure. Referring to FIG. 2 and also to FIG. 1, when the RF frontend module 120 is used for signal jamming, the power amplifier 122 can operate in the compression region R_{C} between the linear region R_{L} and the saturation region R_{S}, thereby outputting the RF signal RT_{P} (e.g. an RF signal in the sets of RF signals {RT₁}-{RT_{N}}) with a power level close to the 1 dB compression point P_{1 dB}. For example, the RF signal RT_{P} can be a frequency-modulated signal with a predetermined bandwidth (or a broadband jamming signal), which is provided for covering an operating frequency band of the target device 102. The power amplifier 122 that operates in the compression region R_{C} can achieve high efficiency and acceptable signal distortion while ensuring the RF signal RT_{P} has the predetermined bandwidth.

To facilitate understanding of the present disclosure, some implementations are given below for further description of the proposed active jammer architecture. However, the implementations are provided for illustrative purposes, and are not intended to limit the scope of the present disclosure. Other embodiments employing the jammer architecture shown in FIG. 1 are within the scope of the present disclosure.

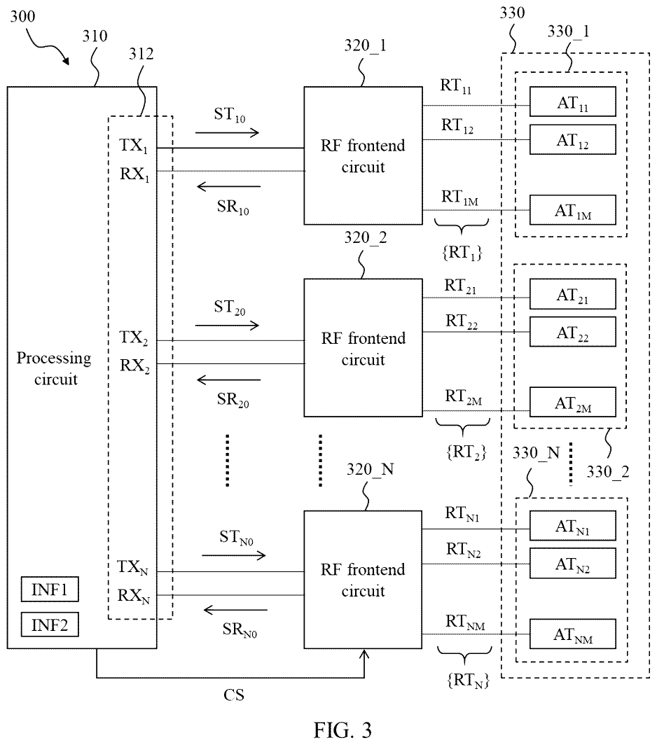

FIG. 3 is a block diagram of an implementation of the RF jammer 100 shown in FIG. 1 in accordance with some embodiments of the present disclosure. The RF jammer 300 may include a processing circuit 310, RF frontend circuits 320_1-320_N, and an antenna array 330. The processing circuit 310 can serve as an embodiment of the processing circuit 110 shown in FIG. 1; the RF frontend circuits 320_1-320_N can serve as at least a part of the RF frontend module 120 shown in FIG. 1; the antenna array 330 can serve as an embodiment of the antenna array 130 shown in FIG. 1.

The processing circuit 310 is configured to transmit N output signals ST₁₀-ST_{N0} (i.e. N singleton sets each having a single output signal) via N channels TX₁-TX_{N} of the multi-channel interface 312, respectively. By way of example but not limitation, the processing circuit 310 can be implemented as a multi-channel RF SoC, and the multi-channel interface 312 can include N RF sampling digital-to-analog converters (DACs; not shown in FIG. 3), which can transmit the output signals ST₁₀-ST_{N0} via the channels TX₁-TX_{N} respectively.

In the present embodiment, the processing circuit 310 can be further configured to receive N input signals SR₁₀-SR_{N0} via N channels RX₁-RX_{N} of the multi-channel interface 312 for signal calibration. By way of example but not limitation, the processing circuit 310 can be implemented as a multi-channel RF SoC, and the multi-channel interface 312 can include N RF sampling analog-to-digital converters (ADCs; not shown in FIG. 3), which can receive the input signals SR₁₀-SR_{N0} via the channels RX₁-RX_{N} respectively.

The RF frontend circuits 320_1-320_N are coupled to the channels TX₁-TX_{N} to receive the output signals ST₁₀-ST_{N0}, respectively. Each RF frontend circuit is configured to generate a set of RF signals according to a corresponding output signal and the position information INF1. For example, the processing circuit 310 can generate the control signal CS according to the position information INF1, and the RF frontend circuit 320_i (i=1, 2, . . . , N) is configured to generate a set of RF signals {RTᵢ} according to the output signal STᵢ₀ and the control signal CS. The phase relationship between RF signals in the same set of RF signals {RTᵢ} can be set or determined according to the control signal CS. In addition, the RF frontend circuits 320_1-320_N can be further configured to generate N input signals SR₁₀-SR_{N0} according to the sets of RF signals {RT₁}-{RT_{N}}, thereby transmitting the input signals SR₁₀-SR_{N0} to the channels RX₁-RX_{N} respectively.

In the present embodiment, the RF frontend circuits 320_1-320_N can be configured to process/generate signals with different frequency bands. By way of example but not limitation, the RF frontend circuit 320_1 can be configured to process an output signal with a frequency falling within the L1 band, or an output signals with a frequency range covering the L1 band. In other words, the frequency of the output signal SR₁₀ transmitted by the processing circuit 310 can be within the L1 band, or the frequency range of the output signal SR₁₀ can cover the L1 band. Additionally or alternatively, the RF frontend circuit 320_1 can be configured to generate RF signals used for beamforming; the generated RF signals have frequencies falling within the L1 band or have frequency ranges covering the L1 band. In other words, the frequency of each RF signal in the set of RF signals {RT₁} can be within the L1 band, or the frequency range of each RF signal in the set of RF signals {RT₁} can cover the L1 band.

Similarly, in some examples, the RF frontend circuit 320_2 can be configured to process an output signal with a frequency falling within the L2 band, or an output signal with a frequency range covering the L2 band; additionally or alternatively, the RF frontend circuit 320_2 can be configured to generate RF signals used for beamforming that have frequencies falling within the L2 band or frequency ranges covering the L2 band. In some examples, the RF frontend circuit 320_3 can be configured to process an output signal with a frequency falling within the S band, or an output signal with a frequency range covering the S band; additionally or alternatively, the RF frontend circuit 320_3 can be configured to generate RF signals used for beamforming that have frequencies falling within the S band or frequency ranges covering the S band. In some examples, the RF frontend circuit 320_4 can be configured to process an output signal with a frequency falling within the C band, or an output signal with a frequency range covering the C band; additionally or alternatively, the RF frontend circuit 320_4 can be configured to generate RF signals used for beamforming that have frequencies falling within the C band or frequency ranges covering the C band.

The antenna array 330 includes, but is not limited to, N antenna subarrays 330_1-330_N that are coupled to the RF frontend circuits 320_1-320_N respectively. The antenna subarrays 330_1-330_N are arranged to receive the sets of RF signals {RT₁}-{RT_{N}} to emit the beamforming signals SJ₁-SJ_{N}. In the example shown in FIG. 3, each set of RF signals received by an antenna subarray can include M RF signals (M>1), and each antenna subarray can include M antennas (also referred to as antenna/radiating elements). In other words, the antenna subarray 330_i (i=1, 2, . . . , N) can utilize the antenna elements ATᵢ₁-AT_{iM} to combine the RF signals RTᵢ₁-RT_{iM} into the beamforming signal SJᵢ.

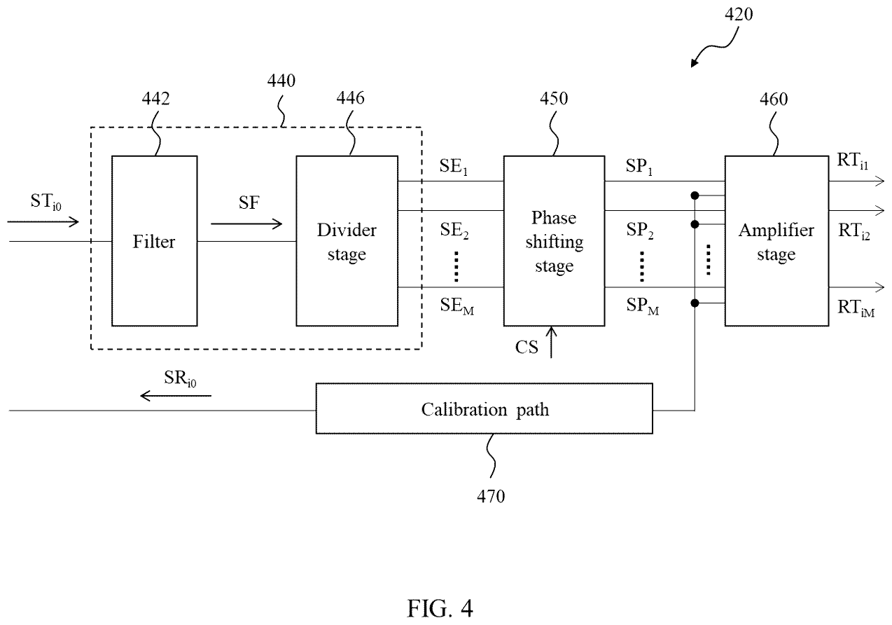

In the embodiment shown in FIG. 3, the RF jammer 300 can utilize an analog phased array to realize signal interception. For example, the RF frontend module 320 can employ phase shifter architecture to adjust the phase shifts of the RF signals received by the antenna array 330; the antenna array 330 can receive the phase shifted RF signals for beamforming. Referring to FIG. 4, a block diagram of the RF frontend circuit 320_i (i=1, 2, . . . , N) shown in FIG. 3 is illustrated in accordance with some embodiments of the present disclosure. In the present embodiment, the RF frontend circuit 420 can employ phase shifter architecture to adjust a phase shift of an RF signal in an analog manner. The RF frontend circuit 420 may include, but is not limited to, a divider stage 440, a phase shifting stage 450 and an amplifier stage 460.

The divider stage 440 (also referred to as a power divider stage) is arranged to split the output signal STᵢ₀ into M electrical signals SE₁-SE_{M}. In the present embodiment, the divider stage 440 may include a filter 442 and a power divider circuit 446. The filter 442 is configured to process the output signal STᵢ₀ to generate a filtered signal SF (i.e. a filtered version of the output signal STᵢ₀). By way of example but not limitation, the filter 442 can be controlled by the processing circuit 310 shown in FIG. 3 to filter out or reduce unwanted noise in the output signal STᵢ₀. In some examples, the filter 442 can be controlled by the processing circuit 310 shown in FIG. 3, and is configured to process the output signal STᵢ₀ according to the frequency band information INF2 shown in FIG. 3 to thereby obtain the filtered signal SF with a predetermined frequency band (e.g. L1 band, L2 band, S band or C band). Note that the filter 442 may be omitted in some embodiments where the frequency of the output signal STᵢ₀ is within the predetermined frequency band. In addition, the power divider circuit 446 is configured to split the filtered signal SF into the electrical signals SE₁-SE_{M}. By way of example but not limitation, the power divider circuit 446 can be implemented using a divider tree structure with one or more layers.

The phase shifting stage 450, coupled to the divider stage 440, is configured to perform phase shifting operation on the electrical signals SE₁-SE_{M} according to the control signal CS and accordingly generate M phase shifted signals SP₁-SP_{M}. For example, the electrical signals SE₁-SE_{M} can have the same phase; the phase shifting stage 450 can apply corresponding phase shifts to the electrical signals SE₁-SE_{M} according to the control signal CS, thereby generating the phase shifted signals SP₁-SP_{M}.

The amplifier stage 460, coupled to the phase shifting stage 450, is configured to amplify the phase shifted signals SP₁-SP_{M} to generate the RF signals RTᵢ₁-RT_{iM}. Each RF signal can be outputted through a corresponding power amplifier (not shown in FIG. 4) in the amplifier stage 460. The power amplifier can operate in a compression region between a linear region and a saturation region to efficiently output the RF signal with a predetermined bandwidth.

In the present embodiment, the RF frontend circuit 420 may further include a calibration path 470, which is coupled to the amplifier stage 460. The calibration path 470 is arranged to generate the input signal SRᵢ₀ according to the RF signals RTᵢ₁-RT_{iM} provided by the amplifier stage 460. By way of example but not limitation, the processing circuit 310 shown in FIG. 3 can calibrate the output signal STᵢ₀, apply phase shifts to the electrical signals SE₁-SE_{M}, and/or apply amplification gains to the phase shifted signals SP₁-SP_{M} according to the input signal SRᵢ₀.

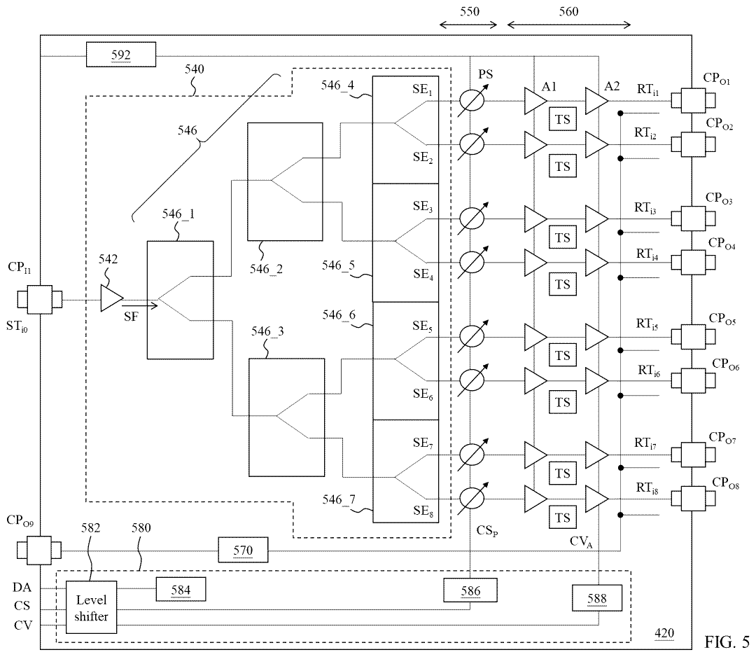

FIG. 5 is a diagram of an implementation of the RF frontend circuit 420 shown in FIG. 4 in accordance with some embodiments of the present disclosure. In the present embodiment, the RF frontend circuit 520 can generate RF signals RTᵢ₁-RTᵢ₈ (i.e. M=8) covering the operating frequency band Bᵢ of the target device 102 shown in FIG. 1. However, this is not intended to limit the scope of the present disclosure. The RF frontend circuit 520 may include, but is not limited to, a divider stage 540, a phase shifting stage 550, an amplifier stage 560 and a digital step attenuator (DSA) 570, which can serve as embodiments of the divider stage 440, the phase shifting stage 450, the amplifier stage 460 and the calibration path 470 shown in FIG. 4 respectively.

The divider stage 540 may include, but is not limited to, a filter 542 and a divider tree 546. The filter 542 can receive the output signal STᵢ₀ via a coupler (or an input terminal) CP_{I1}. The divider tree 546 can be implemented using a plurality of dividers 546_1-546_7 to split the filtered signal SF into the electrical signals SE₁-SE₈. The phase shifting stage 550 includes a plurality of phase shifters PS. Each phase shifter can apply a phase shift to a corresponding electrical signal according to the control signals CS_{P}, thereby generating a corresponding phase shifted signal. In the present embodiment, the operating frequency band of each phase shifter can cover the operating frequency band Bᵢ of the target device 102 shown in FIG. 1, such as L1 band, L2 band, S band or C band.

The amplifier stage 560 may include, but is not limited to, a plurality of driver amplifiers A1 and a plurality of power amplifiers A2. The amplifier stage 560 utilizes a driver amplifier and a corresponding power amplifier to amplify a phase shifted signal, thereby generating a corresponding RF signal. In the present embodiment, the operating voltage (e.g. a gate bias voltage of a transistor) of each power amplifier can be set according to the control signal CV_{A}, allowing the power amplifier to operate in a predetermined operating region (e.g. a compression region). The RF signals RTᵢ₁-RTᵢ₈ can be sent to a corresponding antenna subarray shown in FIG. 3 via couplers (or output terminals) CP_{O1}-CP_{O8}.

The DSA 570 is arranged to attenuate the RF signals RTᵢ₁-RTᵢ₈, and transmit the attenuated signals to the processing circuit 310 shown in FIG. 3 via a coupler (or an output terminal) CP_{O9}. By way of example but not limitation, the DSA 570 can perform switching to attenuate one of the RF signals RTᵢ₁-RTᵢ₈ and output the attenuated signal via the coupler CP_{O9}.

In the present embodiment, the RF frontend circuit 520 may further include a control circuit 580, a power supply circuit 592, and a plurality of temperature sensors TS. The control circuit 580 is configured to generate the control signals CS_{P} and CV_{A} according to the control signals CS and CV provided by the processing circuit 310 shown in FIG. 3. The control circuit 580 includes, but is not limited to, a level shifter 582, a memory 584, a shift register 586 and a digital-to-analog converter (DAC) 588. The level shifter 582 is configured to perform level shifting operation on the input data DA, the control signal CS and the control signal CV. The input data DA may can include, but is not limited to, identification information on the RF frontend circuit 520 and/or preset data for phase shifts. The memory 584 is arranged to store output data and/or output signals of the level shifter 582. The shift register 586 is arranged to generate the control signal CS_{P} according to the level shifted control signal CS. The DAC 588 is arranged to generate the control signal CV_{A} according to the level shifted control signal CV.

The power supply circuit 592 is arranged to provide power to the phase shifters PS, the driver amplifiers A1, and the power amplifiers A2. The temperature sensors TS are arranged to detect the temperatures of the power amplifiers A2, respectively. The control circuit 580 can adjust a phase shift applied by a phase shifter according to a temperature detection result of a corresponding power amplifier.

Consider a case where the RF frontend circuit 520 is configured to generate the RF signals RTᵢ₁-RTᵢ₈ that cover L1 band. In operation, the control circuit 580 can set the respective phase shifts applied to the phase shifters PS to a predetermined/initial value. Next, the control circuit 580 can receive the output signal STᵢ₀ with a bandwidth equal to that of L1 band, and the divider tree 546 can split the filtered version of the output signal STᵢ₀ (i.e. the filtered signal SF) into the electrical signals SE₁-SE₈. The phase shifting stage 550 applies corresponding phase shifts to the electrical signals SE₁-SE₈ according to the control signal CS_{P}. The amplifier stage 560 processes the phase shifted signals SP₁-SP₈ according to the control signal CV_{A}, thereby generating the RF signals RTᵢ₁-RTᵢ₈. The control circuit 580 can selectively adjust the control signal CV_{A} according to the temperature detection results generated by the temperature sensors TS. Additionally or alternatively, the processing circuit 310 shown in FIG. 3 can selectively adjust the output signal STᵢ₀ and/or the control signal CS according to the input signal SRᵢ₀.

Note that the circuit structures described above are provided for illustrative purposes, and are not intended to limit the scope of the present disclosure. In some embodiments, at least a part of the control circuit 580 shown in FIG. 5 can be integrated into the processing circuit 310 shown in FIG. 3. For example, the shift register 586 shown in FIG. 5 can be integrated into the processing circuit 310 shown in FIG. 3. As another example, the shift register 586 shown in FIG. 5 may be omitted; the control signal CS can be inputted to the phase shifters PS to regulate the phase shifts applied thereto.

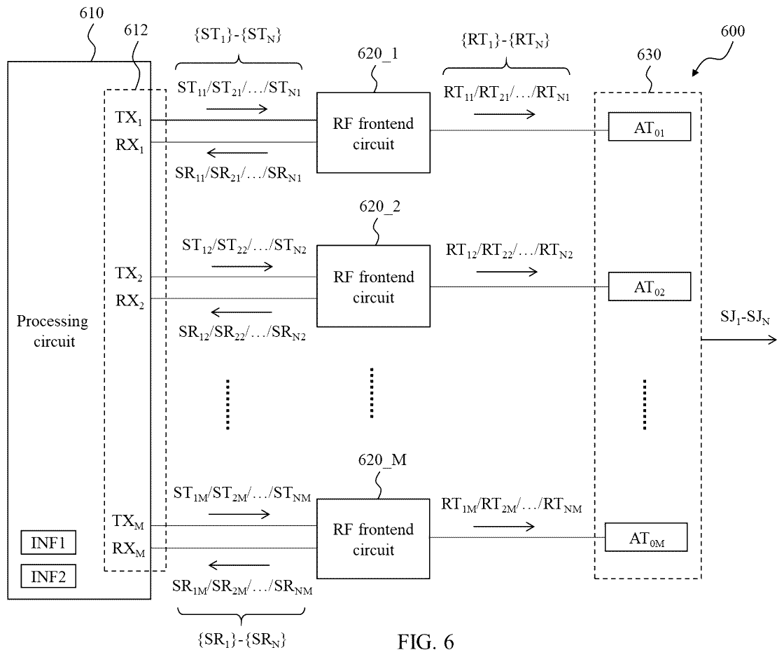

FIG. 6 is a block diagram of another implementation of the RF jammer 100 shown in FIG. 1 in accordance with some embodiments of the present disclosure. The RF jammer 600 may include a processing circuit 610, M RF frontend circuits 620_1-620_M, and an antenna array 630. The processing circuit 610 can serve as an embodiment of the processing circuit 110 shown in FIG. 1. The RF frontend circuits 620_1-620_M can serve as an embodiment of at least a part of the RF frontend module 120 shown in FIG. 1. The antenna array 630 can serve as an embodiment of the antenna array 130 shown in FIG. 1. In the present embodiment, the RF jammer 600 can utilize a digital phased array to realize signal interception. For example, the processing circuit 610 can perform phase control operations on signals, and output the resulting signals to the RF frontend circuits 620_1-620_M; the antenna array 630 can receive phase shifted RF signals from the RF frontend circuits 620_1-620_M to generate beamforming signals.

The processing circuit 610 is configured to generate the sets of output signals {ST₁}-{ST_{N}} according to the position information INF1 and the frequency band information INF2, and transmit the sets of output signals {ST₁}-{ST_{N}} via the channels TX₁-TX_{M} of the multi-channel interface 612. The set of output signals {STᵢ} (i=1, 2, . . . , N) includes M output signals STᵢ₁-ST_{iM} that are transmitted via the channels TX₁-TX_{M} respectively, where M is an integer greater than one. In other words, the channels TX₁-TX_{M} can be shared between the sets of output signals {ST₁}-{ST_{N}}. For example, the processing circuit 610 can transmit the sets of output signals {ST₁}-{ST_{N}} in sequence via the channels TX₁-TX_{M}.

In the present embodiment, the processing circuit 610 can control a phase relationship between the M output signals STᵢ₁-ST_{iM} in the set of output signals {STᵢ} according to the position information INF1. For example, the processing circuit 610 can apply corresponding time delays to M signals with the same frequency according to the position information INF1, thereby generating the output signals STᵢ₁-ST_{iM} with different phase shifts; As another example, the processing circuit 610 can perform digital signal processing on M signals with the same frequency according to the position information INF1, thereby generating the output signals STᵢ₁-ST_{iM} with different phase shifts.

The output signals STᵢ₁-ST_{iM} in the set of output signals {STᵢ} can have the same frequency, which is different from the frequencies of output signals in other sets of output signals. The processing circuit 610 can determine the frequencies of the output signals STᵢ₁-ST_{iM} according to an operating frequency band of the target device 102 shown in FIG. 1. In the present embodiment, the frequency band information INF2 can indicate the operating frequency bands B₁-B_{N} of the target device 102 shown in FIG. 1. The processing circuit 610 can determine the frequencies of the output signals STᵢ₁-ST_{iM} according to the operating frequency band Bᵢ. The frequencies of the output signals STᵢ₁-ST_{iM} can be within the operating frequency band Bᵢ, or the frequency ranges of the output signals STᵢ₁-ST_{iM} can cover the operating frequency band Bi. Thus, the frequency ranges of the sets of output signals {ST₁}-{ST_{N}} can cover different operating frequency bands. By way of example but not limitation, the frequency range of the set of output signals {ST₁} can cover L1 band, the frequency range of the set of output signals {ST₂} can cover L2 band, the frequency range of the set of output signals {ST₃} can cover S band, and/or the frequency range of the set of output signals {ST₄} can cover C band.

The processing circuit 610 can be further configured to receive N sets of input signals {SR₁}-{SR_{N}} via M channels RX₁-RX_{M} of the multi-channel interface 612 for signal calibration. Each set of input signals {SRi} includes M input signals SRᵢ₁-SR_{iM}. By way of example but not limitation, the processing circuit 610 can be implemented as a multi-channel RF SoC, and the multi-channel interface 612 can include M RF sampling DACs and M RF sampling ADCs (not shown in FIG. 6). The M RF sampling DACs can send the output signals STᵢ₁-ST_{iM} via the channels TX₁-TX_{M} respectively, and the M RF sampling ADCs can receive the input signals SRᵢ₁-SR_{iM} via the channels RX₁-RX_{M}, respectively.

The RF frontend circuits 620_1-620_M are coupled to the channels TX₁-TX_{M} respectively. The RF frontend circuits 620_1-620_M are configured to receive the output signals STᵢ₁-ST_{iM} in the set of output signals {STᵢ} to generate the RF signals RTᵢ₁-RT_{iM} in the set of RF signals {RTᵢ}, respectively. In other words, the sets of RF signals {RT₁}-{RT_{N}} can share the RF frontend circuits 620_1-620_M. Each RF frontend circuit can generate an RF signal in each set of RF signals. In addition, the frequency of each of the RF signals RTᵢ₁-RT_{iM} can be equal to the frequency of each of the output signals STᵢ₁-ST_{iM}. The frequency ranges of the sets of RF signals {RT₁}-{RT_{N}} can cover different operating frequency bands.

In the present embodiment, the RF signals RTᵢ₁-RT_{iM} can be outputted from M power amplifiers (not shown in FIG. 6) of the RF frontend circuits 620_1-620_M, respectively. Each power amplifier can operate in a compression region between a linear region and a saturation region to efficiently output an RF signal with a predetermined bandwidth. In addition, the RF frontend circuits 620_1-620_M can be further configured to generate N sets of input signals {SR₁}-{SR_{N}} according to the sets of RF signals {RT₁}-{RT_{N}}, and transmit the sets of input signals {SR₁}-{SR_{N}} to the processing circuit 610 via the shared M channels RX₁-RX_{M}.

The antenna array 630, coupled to the RF frontend circuits 620_1-620_M, is arranged to receive the sets of RF signals {RT₁}-{RT_{N}} and emit the beamforming signals SJ₁-SJ_{N}. The antenna array 630 includes, but is not limited to, M antennas (e.g. antenna elements or radiating elements) AT₀₁-AT_{0M} that are coupled to the RF frontend circuits 620_1-620_M respectively. The antennas AT₀₁-AT_{0M} are arranged to receive the RF signals RTᵢ₁-RT_{iM} in the set of RF signals {RTᵢ} respectively to thereby emit the corresponding beamforming signal SJᵢ. In other words, the antenna array 630 can utilize the antennas AT₀₁-AT_{0M} to combine the RF signals RTᵢ₁-RT_{iM} into the beamforming signal SJᵢ.

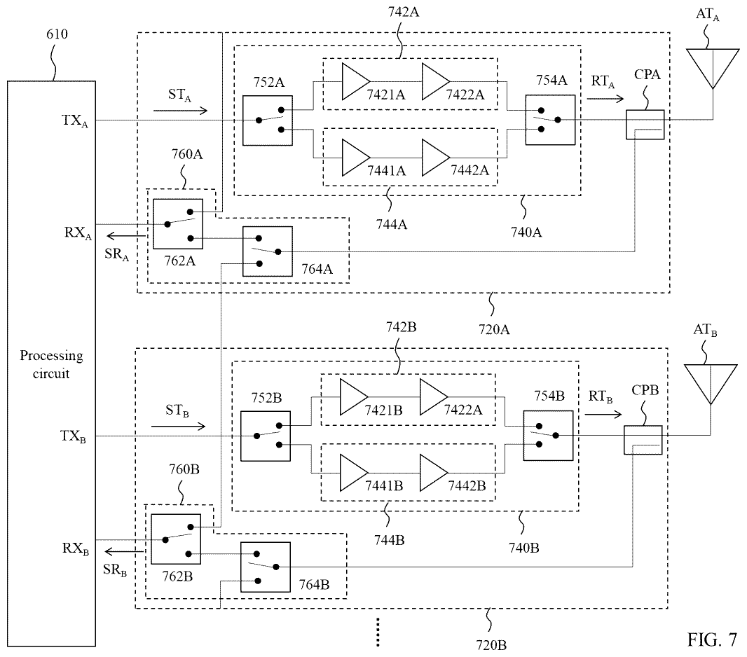

FIG. 7 is a diagram of an implementation of two adjacent RF frontend circuits shown in FIG. 6 in accordance with some embodiments of the present disclosure. In the present embodiment, the RF frontend circuits 720A and 720B can have substantially the same structure, and can both generate RF signals covering multiple frequency bands.

The RF frontend circuit 720A may include, but is not limited to, an amplifier stage 740A, a coupler CPA and a calibration path 760A. The operating frequency bandwidth of the amplifier stage 740A can cover the operating frequency bands B₁-B_{N} of the target device 102 shown in FIG. 1. The amplifier stage 740A is configured to amplify the output signal ST_{A} on the channel TX_{A} (e.g. the output signal ST₁₁ in the set of output signals {ST₁} shown in FIG. 6) to generate a corresponding RF signal RT_{A} (e.g. the RF signal RT₁₁ in the set of RF signals {RT₁} shown in FIG. 6).

The amplifier stage 740A can achieve broadband amplification by switching between different amplifier circuits with different operating frequency ranges. In the present embodiment, the amplifier stage 740A may include, but is not limited to, the amplifier circuits 742A and 744A that have different operating frequency ranges. Each amplifier circuit is selectively coupled between the channel TX_{A} and the antenna AT_{A} (e.g. the antenna AT₁₁ shown in FIG. 6).

For example, the amplifier circuit 742A can be implemented using a driver amplifier 7421A and a power amplifier 7422A; the amplifier circuit 744A can be implemented using a driver amplifier 7441A and a power amplifier 7442A. The operating frequency ranges of the driver amplifier 7421A and the power amplifier 7422A are substantially the same, and the operating frequency ranges of the driver amplifier 7441A and the power amplifier 7442A are substantially the same. The maximum operating frequency of the driver amplifier 7421A and the power amplifier 7422A is lower than that of the driver amplifier 7441A and the power amplifier 7442A. When the amplifier stage 740A operates as a low-frequency amplifier, the switch 752A is configured to couple the channel TX_{A} to the driver amplifier 7421A, and the switch 754A is configured to couple the power amplifier 7422A to the coupler CPA; when the amplifier stage 740A operates as a high-frequency amplifier, the switch 752A is configured to couple the channel TX_{A} to the driver amplifier 7441A, and the switch 754A is configured to couple the power amplifier 7442A to the coupler CPA.

In addition, the coupler CPA can couple the RF signal RT_{A} into the antenna AT_{A}, and couple the RF signal RT_{A} into the calibration path 760A. The calibration path 760A can couple the signal from the coupler CPA to the channel RX_{A} to thereby generate the input signal SR_{A} (e.g. the input signal SR₁₁ in the set of input signals {SR₁} shown in FIG. 6). In the present embodiment, the calibration path 760A can include the switches 762A and 764A. The switch 762A is configured to selectively couple the coupler CPA to the switch 764A, and the switch 764A is configured to selectively couple the switch 762A to the channel RX_{A}.

Similarly, the RF frontend circuit 720B may include, but is not limited to, an amplifier stage 740B, a coupler CPB and a calibration path 760B. The operating frequency bandwidth of the amplifier stage 740B can cover multiple operating frequency bands B₁-B_{N} of the target device 102 shown in FIG. 1. The amplifier stage 740B is configured to amplify the output signal ST_{B} on the channel TX_{B} (e.g. the output signal ST₁₂ in the set of output signals {ST₁} shown in FIG. 6) to generate a corresponding RF signal RT_{B} (e.g. the RF signal RT₁₂ in the set of RF signals {RT₁} shown in FIG. 6). The amplifier stage 740B may include, but is not limited to, the amplifier circuits 742B and 744B, and the switches 752B and 754B. The operating frequency range of the amplifier circuit 742B is the same as that of the amplifier circuit 742A, and the operating frequency range of the amplifier circuit 744B is the same as that of the amplifier circuit 744A. The amplifier circuit 742B can be implemented using a driver amplifier 7421B and a power amplifier 7422B, and the amplifier circuit 744B can be implemented using a driver amplifier 7441B and a power amplifier 7442B. As the circuit structure of the amplifier stage 740B can be substantially identical to the circuit structure of the amplifier stage 740A, similar descriptions are omitted here for brevity.

The coupler CPB can couple the RF signal RT_{B} into the antenna AT_{B} (e.g. the antenna AT₁₂ shown in FIG. 6), and couple the RF signal RT_{B} into the calibration path 760B. The calibration path 760B can couple the signal from the coupler CPB to the channel RX_{B} to thereby generate the input signal SR_{B} (e.g. the input signal SR₁₂ in the set of input signals {SR₁} shown in FIG. 6). In the present embodiment, the calibration path 760B can include the switches 762B and 764B.

In operation, each RF frontend circuit can enter a calibration mode. For example, the switch 762A can be coupled between the coupler CPA and the switch 764A, and the switch 764A can be coupled between the switch 762A and the channel RX_{A}, allowing the processing circuit 630 to calibrate the output signal ST_{A} according to the RF signal RT_{A}. As another example, the switch 762A can be coupled between the coupler CPA and the switch 764B, and the switch 764B can be coupled between the switch 762A and the channel RX_{B}, allowing the processing circuit 630 to calibrate the output signal ST_{A} according to the RF signal RT_{B}.

Additionally, in some cases where the RF frontend circuits 720A and 720B are configured to generate RF signals RT_{A} and RT_{B} that cover a lower operating frequency band (e.g. L1 band), the amplifier circuit 742A can be coupled between the channel TX_{A} and the coupler CPA via the switches 752A and 754A, and the amplifier circuit 742B can be coupled between the channel TX_{B} and the coupler CPB via the switches 752B and 754B. In some cases where the RF frontend circuits 720A and 720B are configured to generate RF signals RT_{A} and RT_{B} that cover a higher operating frequency band (e.g. C band), the amplifier circuit 744A can be coupled between the channel TX_{A} and the coupler CPA via the switches 752A and 754A, and the amplifier circuit 744B can be coupled between the channel TX_{B} and the coupler CPB via the switches 752B and 754B.

Note that the circuit structures described above are provided for illustrative purposes, and are not intended to limit the scope of the present disclosure. In some embodiments, the amplifier stage 740A can be implemented using a broadband amplifier circuit placed between the switches 752A and 754A. In some embodiments, the amplifier stage 740A can be implemented using more than two amplifier circuits, which can have different operating frequency ranges and are placed in parallel between the switches 752A and 754A. In some embodiments, each power amplifier, which is included in the amplifier stages 740A/740B and arranged to output an RF signal, can operate in a compression region. In some embodiments, each RF frontend circuit may include temperature sensors and shift registers to regulate the gate bias voltages of the power amplifiers.

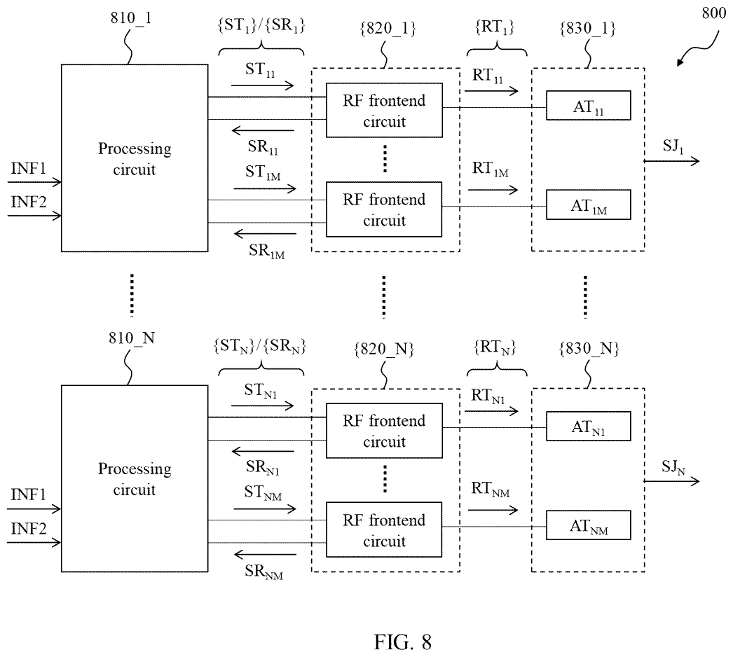

FIG. 8 is a block diagram of another implementation of the RF jammer 100 shown in FIG. 1 in accordance with some embodiments of the present disclosure. The RF jammer 800 can include a processing circuit 810, N sets of RF frontend circuits {820_1}-{820_N}, and N antenna subarrays {830_1}-{830_N}. The processing circuit 810 can serve as an embodiment of the processing circuit 110 shown in FIG. 1. The sets of RF frontend circuits {820_1}-{820_N} can serve as an embodiment of at least a part of the RF frontend module 120 shown in FIG. 1. The antenna subarrays {830_1}-{830_N} can serve as an embodiment of the antenna array 130 shown in FIG. 1. In the present embodiment, the RF jammer 800 can utilize a digital phased array to realize signal interception. For example, the processing circuit 810 can perform phase control operations on signals, and output the resulting signals to the sets of RF frontend circuits {820_1}-{820_N}; the antenna subarrays {830_1}-{830_N} can receive phase shifted RF signals from the sets of RF frontend circuits {820_1}-{820_N} to generate beamforming signals.

The processing circuit 810 can include N processing devices 810_1-810_N, which can be configured to generate N sets of output signals {ST₁}-{ST_{N}} respectively. Each processing device can be implemented using the processing circuit 610 shown in FIG. 6. By way of example but not limitation, the processing device 810_i (i=1, 2, . . . , N) can generate a set of output signals {STᵢ} containing M output signals STᵢ₁-ST_{iM} (M is an integer greater than one) according to the position information INF1 and the operating frequency band Bᵢ indicated by the frequency band information INF2. The phase relationship between the output signals STᵢ₁-ST_{iM} can be determined according to the position information INF1. The frequencies of the output signals STᵢ₁-ST_{iM} can be within the operating frequency band Bᵢ, or the frequency ranges of the output signals STᵢ₁-ST_{iM} can cover the operating frequency band Bᵢ. In other words, the sets of output signals {ST₁}-{ST_{N}} generated by the processing devices 810_1-810_N can cover different operating frequency bands B₁-B_{N}, respectively.

The sets of RF frontend circuits {820_1}-{820_N} are configured to receive the sets of output signals {ST₁}-{ST_{N}} to generate the sets of RF signals {RT₁}-{RT_{N}}, respectively. Each set of RF frontend circuits can include M RF frontend circuits, which can be implemented using the RF frontend circuits 620_1-620_M shown in FIG. 6 respectively. For example, the RF frontend circuits 820_11-820_1M in the set of RF frontend circuits {820_1} are configured to receive the output signals ST₁₁-ST_{1M} in the set of output signals {ST₁} to generate the RF signals RT₁₁-RT_{1M} in the set of RF signals {RT₁}, respectively.

The antenna subarrays {830_1}-{830_N}, coupled to the sets of RF frontend circuits {820_1}-{820_N} respectively, are arranged to receive the sets of RF signals {RT₁}-{RT_{N}} and emit the beamforming signals SJ₁-SJ_{N}. Each antenna subarray can include M antennas, which can be implemented using the antennas AT₀₁-AT_{0M} shown in FIG. 6. For example, the antennas AT₁₁-AT_{1M} of the antenna subarray {830_1} are arranged to receive the RF signals RT₁₁-RT_{1M} in the set of RF signals {RT₁} to emit the corresponding beamforming signal SJ₁.

As those skilled in the art can appreciate the operational of the RF jammer 800 after reading the paragraphs directed to FIG. 1 to FIG. 7, further description is omitted here for brevity.

In some embodiments, the proposed RF jammer can incorporate target position detection and/or frequency band detection. Referring again to FIG. 1, the RF jammer 100 can further include an RF frontend circuit 121, and one or more antennas 131. In some examples, the antennas 131 can be arranged in an array, and used to receive multiple electromagnetic wave signals S_{EM1} from the target device 102 to thereby generate multiple RF signals RR₀₁. The RF frontend circuit 121 is coupled to the antennas 131 and the processing circuit 110, and is configured to process the RF signals RR₀₁ outputted from the antennas 131 to generate multiple input signals SR₀₁. The processing circuit 110 is configured to generate the frequency band information INF1 according to the input signals SR₀₁. For example, the processing circuit 110 can apply beamforming to the input signals SR₀₁ to thereby determine the position information INF1 on the target device 102.

In some examples, a single antenna 131 can receive the electromagnetic wave signal S_{EM2} sent from the target device 102 to generate the RF signal RR₀₂. The RF frontend circuit 121 is configured to process the RF signal RR₀₂ outputted from the antenna 131 to generate the input signal SR2. The processing circuit 110 is configured to generate the frequency band information INF2 according to the input signal SR₀₂. For example, the processing circuit 110 can determine the operating frequency bands B₁-B_{N} of the target device 102 according to the input signal SR₀₂. In addition, the processing circuit 110 can be further configured to set the frequencies of the sets of output signals {ST₁}-{ST_{N}} according to the operating frequency bands B₁-B_{N}.

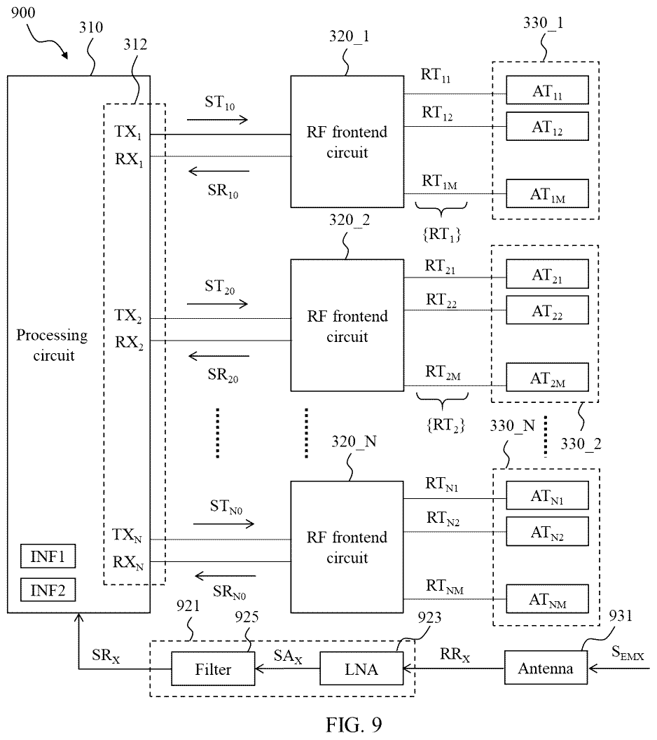

FIG. 9 is a block diagram of an implementation of the RF jammer 100 shown in FIG. 1 in accordance with some embodiments of the present disclosure. The circuit structure of the RF jammer 900 is substantially identical/similar to that of the RF jammer 300 shown in FIG. 3 except for a frequency band detection block. In the present embodiment, the RF jammer 900 utilized the RF frontend circuit 921 and the antenna 931 to implement the frequency band detection block. The RF frontend circuit 921 and the antenna 931 can serve as embodiments of the RF frontend circuit 121 and the antenna 131 shown in FIG. 1, respectively.

The antenna 931 can be arranged to receive the electromagnetic wave signal S_{EMX} sent from the target device 102 shown in FIG. 1 to generate the RF signal RR_{X}. The RF frontend circuit 921 can be configured to process the RF signal RR_{X} outputted from the antenna 931 to generate the input signal SR_{X}, which can carry the information on the operating frequency band Bᵢ (i=1, 2, . . . , N) of the target device 102 shown in FIG. 1. By way of example but not limitation, the RF frontend circuit 921 can include a low-noise amplifier (LNA) 923 and a filter 925. The LNA 923 is configured to amplify the RF signal RR_{X} to generate the amplified signal SA_{X}, and the filter 925 is configured to process the amplified signal SA_{X} to generate the input signal SR_{X}.

In addition, the processing circuit 310 is configured to generate the output signal STᵢ₀ according to the input signal SR_{X}. For example, the processing circuit 310 can determine the operating frequency band Bᵢ of the target device 102 according to the input signal SR_{X}, and set the frequency/bandwidth of the output signal STᵢ₀ according to the operating frequency band Bᵢ. As those skilled in the art can appreciate the operational of the RF jammer 900 after reading the paragraphs directed to FIG. 1 to FIG. 8, further description is omitted here for brevity.

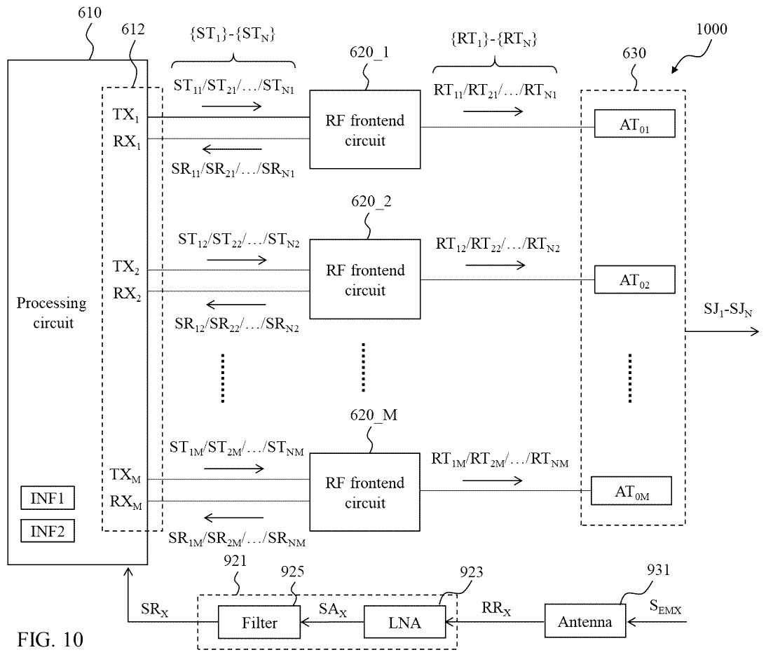

FIG. 10 is a block diagram of an implementation of the RF jammer 100 shown in FIG. 1 in accordance with some embodiments of the present disclosure. The circuit structure of the RF jammer 1000 is substantially identical/similar to that of the RF jammer 600 shown in FIG. 6. In the present embodiment, the RF jammer 1000 utilizes the RF frontend circuit 921 and the antenna 931 shown in FIG. 9 to implement the frequency band detection block.

The processing circuit 610 is configured to generate M output signals STᵢ₁-ST_{iM} (M is an integer greater than one) in the set of output signals {STᵢ} (i=1, 2, . . . , N) according to the input signal SR_{X}. For example, the processing circuit 610 can determine the operating frequency band Bᵢ of the target device 102 according to the input signal SR_{X}, and set the frequencies/bandwidths of the output signals STᵢ₁-ST_{iM} according to the operating frequency band Bᵢ. As those skilled in the art can appreciate the operational of the RF jammer 1000 after reading the paragraphs directed to FIG. 1 to FIG. 9, further description is omitted here for brevity.

With the use of active phased array architecture, the proposed RF jammer not only can interfere with and/or neutralize operation of a target device in an active and real-time manner, but also can achieve multi-band or full-band signal interception. Additionally, the proposed RF jammer can incorporate frequency band detection and/or target position detection, thereby achieving an active defense system.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A radio frequency (RF) jammer, comprising:
a processing circuit having a multi-channel interface, the processing circuit being configured to transmit N sets of output signals via the multi-channel interface, wherein N is an integer greater than one;
an RF frontend module, coupled to the multi-channel interface, the RF frontend module being configured to receive the N sets of output signals to generate N sets of RF signals, wherein a phase relationship between RF signals in each set of RF signals is determined according to position information on a target device; and
an antenna array, coupled to the RF frontend module, the antenna array being arranged to receive the N sets of RF signals to emit N beamforming signals directed to the target device.

2. The RF jammer of claim 1, wherein each RF signal is outputted through a power amplifier of the RF frontend module, and the power amplifier operates in a compression region between a linear region and a saturation region.

3. The RF jammer of claim 1, wherein each set of output signals is a singleton set having a single output signal; the processing circuit is configured to transmit N output signals via N channels of the multi-channel interface respectively.

4. The RF jammer of claim 3, wherein the processing circuit is configured to generate a control signal according to the position information on the target device; the RF frontend module comprises:
N RF frontend circuits, coupled to the N channels to receive the N output signals respectively, each RF frontend circuit being configured to generate a set of RF signals according to a corresponding output signal and the control signal.

5. The RF jammer of claim 4, wherein the set of RF signals comprises M RF signals, and M is an integer greater than one; the RF frontend circuit comprises:
a divider stage, arranged to split the output signal into M electrical signals;
a phase shifting stage, coupled to the divider stage, the phase shifting stage being configured to perform phase shifting operation on the M electrical signals according to the control signal, and accordingly generate M phase shifted signals; and
an amplifier stage, coupled to the phase shifting stage, the amplifier stage being configured to amplify the M phase shifted signals to generate the M RF signals.

6. The RF jammer of claim 4, wherein the antenna array comprises:
N antenna subarrays, coupled to the N RF frontend circuits respectively, the N antenna subarrays being arranged to receive the N sets of RF signals to emit the N beamforming signals, respectively.

7. The RF jammer of claim 1, wherein each set of output signals comprises M output signals with a same frequency different from frequencies of output signals in the other sets of output signals, and M is an integer greater than one; the processing circuit is further configured to control a phase relationship between output signals in each set of output signals according to the position information on the target device.

8. The RF jammer of claim 7, wherein the processing circuit is configured to transmit the M output signals in each set of output signals via M channels of the multi-channel interface respectively, and the M channels are shared between the N sets of output signals; the RF frontend module comprises:
M RF frontend circuits, coupled to the M channels, the M RF frontend circuit being configured to receive the M output signals to generate M RF signals in a same set of RF signals, respectively.

9. The RF jammer of claim 8, wherein the antenna array comprises M antennas, coupled to the M RF fronted circuits respectively; each RF fronted circuit comprises:
a plurality of amplifier circuits with different operating frequency ranges, wherein each amplifier circuit is selectively coupled between a corresponding channel and a corresponding antenna.

10. The RF jammer of claim 7, wherein the RF frontend module comprises:
N sets of RF frontend circuits, configured to receive the N sets of output signals to generate the N sets of RF signals, respectively.

11. The RF jammer of claim 10, wherein the antenna array comprises:
N antenna subarrays, coupled to the N RF frontend circuit respectively, the N antenna subarrays being arranged to receive the N sets of RF signals to emit the N beamforming signals, respectively.

12. The RF jammer of claim 1, wherein N frequencies of the N beamforming signals are within N operating frequency bands of the target device, respectively; the processing circuit is configured to determine the N operating frequency bands of the target device according to an input signal, and set respective frequencies of the N sets of output signals according to the N operating frequency bands; the RF jammer further comprises:
an antenna, arranged to receive an electromagnetic wave signal sent from the target device to generate an RF signal; and
an RF frontend circuit, coupled to the antenna and the processing circuit, the RF frontend circuit being configured to process the RF signal outputted from the antenna to generate the input signal.

13. The RF jammer of claim 1, wherein the processing circuit is configured to apply beamforming to a plurality of input signals to determine the position information on the target device; the RF jammer further comprises:
a plurality of antennas arranged in an array, the antennas being arranged to receive a plurality of electromagnetic wave signals sent from the target device to generate a plurality of RF signals; and
an RF frontend circuit, coupled to the antennas the processing circuit, the RF frontend circuit being configured to process the RF signals outputted from the antennas to generate the input signals.

14. A radio frequency (RF) jammer, comprising:
a processing circuit having a multi-channel interface, the processing circuit being configured to generate an output signal having a frequency falling within an operating frequency band of a target device;
a first RF frontend circuit, coupled to the multi-channel interface, the first RF frontend circuit being configured to receive the output signal to generate M RF signals, M being an integer greater than one, wherein the first RF frontend circuit comprises:
a divider stage, arranged to split the output signal into M electrical signals;
a phase shifting stage, coupled to the divider stage, the phase shifting stage being configured to perform phase shifting operation on the M electrical signals according to position information on the target device, and accordingly generate M phase shifted signals; and
an amplifier stage, coupled to the phase shifting stage, the amplifier stage being configured to amplify the M phase shifted signals to generate the M RF signals; and
an antenna array, coupled to the amplifier stage, the antenna array being arranged to receive the M RF signals to emit a beamforming signal directed to the target device.

15. The RF jammer of claim 14, wherein the M RF signals are outputted from M power amplifiers of the amplifier stage, respectively, and each power amplifier operates in a compression region between a linear region and a saturation region.

16. The RF jammer of claim 14, wherein the processing circuit is configured to generate the output signal according to an input signal carrying information on the operating frequency band; the RF jammer further comprises:
an antenna, arranged to receive an electromagnetic wave signal sent from the target device to generate an RF signal; and
a second RF frontend circuit, coupled to the antenna and the processing circuit, the second RF frontend circuit being configured to process the RF signal outputted from the antenna to generate the input signal.

17. A radio frequency (RF) jammer, comprising:
a processing circuit having a multi-channel interface, the processing circuit being configured to generate M output signals according to an operating frequency band of a target device and position information on the target device, M being an integer greater than one, wherein the M output signals have a same frequency falling within the operating frequency band, and a phase relationship between the M output signals is determined according to the position information;
M first RF frontend circuits, coupled to M channels of the multi-channel interface respectively, the M first RF frontend circuits being configured to receive the M output signals via the M channels to generate M RF signals, respectively; and
an antenna array, coupled to the M first RF frontend circuits, the antenna array being arranged to receive the M RF signals to emit a beamforming signal directed to the target device.

18. The RF jammer of claim 17, wherein the M RF signals are outputted from M power amplifiers of the M first RF frontend circuits, respectively, and each power amplifier operates in a compression region between a linear region and a saturation region.

19. The RF jammer of claim 17, wherein the antenna array comprises M antennas, coupled to the M first RF fronted circuits respectively; each first RF frontend circuit comprises:
a plurality of amplifier circuits with different operating frequency ranges, wherein each amplifier circuit is selectively coupled between a corresponding channel and a corresponding antenna.

20. The RF jammer of claim 17, wherein the processing circuit is configured to generate the M output signals according to an input signal carrying information on the operating frequency band; the RF jammer further comprises:
an antenna, arranged to receive an electromagnetic wave signal sent from the target device to generate an RF signal; and
a second RF frontend circuit, coupled between the antenna and the processing circuit, the second RF frontend circuit being configured to process the RF signal outputted from the antenna to generate the input signal.
